(19) United States
(12) Patent Application Publication
(10) Pub. No.: US 2015/0107099 A1
(43) Pub. Date: Apr. 23, 2015

(54) ARTICLE REMOVAL JIG AND ARTICLE ACCOMMODATING BODY

(71) Applicant: FUJITSU LIMITED, Kawasaki-shi (JP)

(72) Inventor: Yuta SASAKI, Kawasaki (JP)

(21) Appl. No.: 14/504,765

(22) Filed: Oct. 2, 2014

(30) Foreign Application Priority Data
Oct. 23, 2013 (JP) 2013-220532

(51) Int. Cl. G11B 33/00

(52) U.S. Cl. CPC G11B 33/00; G11B 33/005
USPC 29/764

(57) ABSTRACT

An article removal jig includes: engaging unit provided to be retractable in relation to an engaging hole provided in an article accommodating device, the engaging unit being engaged in the engaging hole such that an article-accommodating body provided in the article-accommodating device is removed from the article-accommodating device; a handle; a key member configured to be engaged with an engaged unit provided in the engaging unit provided in the article-accommodating body; a driver configured to drive the key member to disengage the engaging unit from the engaging hole; a power source mounted on the article-accommodating body which is permitted to be removed from the article accommodating device, the power source being configured to supply a power to the driver when receiving a removal permission signal of the article-accommodating body which is permitted to be removed; and a first biasing member configured to return the key member to an initial position.

### CROSS-REFERENCE TO RELATED APPLICATIONS

This application is based upon and claims the benefit of priority from the prior Japanese Patent Application No. 2013-220532 filed on Oct. 23, 2013, the entire contents of which are incorporated herein by reference.

### FIELD

The embodiments discussed herein are related to an article removal jig and an article accommodating body.

### BACKGROUND

A magnetic disk device has been known in which a mass storage device is constituted by integrating small magnetic disk devices through an integration device (see, e.g., Patent Document 1). The magnetic disk device disclosed in Patent Document 1 includes a locking mechanism which allows a small magnetic disk device accommodated in a small magnetic disk accommodating unit to be removed or not to be removed. Accordingly, when the small magnetic disk device is normally operated, its removal is prevented. The locking mechanism includes a lock bar and a coil for driving the lock bar, and the lock bar and the coil are provided at the integration device side which includes the small magnetic disk accommodating unit. Besides the locking mechanism in Patent Document 1, various locking mechanisms applicable to a lock of the small magnetic disk device have been suggested. For example, Patent Document 2 discloses a disk tray locking mechanism for a disk device.
[Patent Document 1] Japanese Laid-Open Patent Publication No. S63-279462.
[Patent Document 2] Japanese Laid-Open Patent Publication No. 2000-011512.

Since the magnetic disk device disclosed in Patent Document 1 includes the locking mechanism, a normally operating small magnetic disk device is suppressed from being erroneously drawn out and removed. However, since the locking mechanism including the lock bar and the coil is provided in the integration device, the mounting density of the magnetic disk device may be lowered. As in the magnetic disk device in Patent Document 1, the disk tray locking mechanism disclosed in Patent Document 2 has a solenoid provided at the disk tray side, thereby lowering the mounting density of the device. Thus, the disk tray locking mechanism also has a room for improvement. Further, the structure configured to accommodate an article accommodating body which accommodates an article such as a small magnetic disk device in, for example, a rack, may be applicable to, for example, an archive or a safe. Even when the article accommodating body is applied to those applications, the locking mechanism is thought to be a disturbance in securing various spaces.

Therefore, the article removal jig and the article accommodating body disclosed herein are to improve the space efficiency when an article is accommodated therein. In addition, the present disclosure is to achieve an acting effect which has not been achieved by a conventional technology, by configurations discussed in exemplary embodiments to be described later.

### SUMMARY

According to an aspect of the embodiments, an article removal jig includes: engaging unit provided to be retractable in relation to an engaging hole provided in an article accommodating device, the engaging unit being engaged in the engaging hole such that an article-accommodating body provided in the article-accommodating device is removed from the article-accommodating device; a handle; a key member configured to be engaged with an engaged unit provided in the engaging unit provided in the article-accommodating body; a driver configured to drive the key member to disengage the engaging unit from the engaging hole; a power source mounted on the article-accommodating body which is permitted to be removed from the article accommodating device, the power source being configured to supply a power to the driver when receiving a removal permission signal of the article-accommodating body which is permitted to be removed; and a first biasing member configured to return the key member to an initial position.

The object and advantages of the invention will be realized and attained by means of the elements and combinations particularly pointed out in the claims.

It is to be understood that both the foregoing general description and the following detailed description are exemplary and explanatory and are not restirctive of the invention, as claimed.

### BRIEF DESCRIPTION OF DRAWINGS

FIG. 1 is an explanatory view schematically illustrating a configuration of a disk array device which accommodates active frames in a first exemplary embodiment;

FIG. 2A is a block diagram of the disk array device in the first exemplary embodiment, and FIG. 2B is a block diagram of a disk array device in a comparative example;

FIG. 3 is a perspective view illustrating an article removal jig and the active frame in the first exemplary embodiment;

FIG. 4 is an explanatory view illustrating, partially in cross-section, the article removal jig and the active frame in the first exemplary embodiment;

FIG. 5 is a perspective view illustrating the article removal jig in the first exemplary embodiment when viewed from a bottom side;

FIG. 6 is a cross-sectional view illustrating main portions of the article removal jig and the active frame in the first exemplary embodiment;

FIG. 7 is a cross-sectional view illustrating a main portion of the article removal jig in the first exemplary embodiment in an enlarged scale;

FIG. 8A illustrates the active frame, FIG. 8B illustrates the disk array device, and FIG. 8C is an explanatory view illustrating the state where the active frame is accommodated in the disk array device;

FIG. 9A illustrates a preparation state before the article removal jig is mounted on the active frame in the first exemplary embodiment;

FIG. 9B is an explanatory view illustrating the state where the article removal jig is mounted on the active frame;

FIG. 10 is an explanatory view illustrating the state where an engaging unit is retracted by a key member;

FIG. 11 is an explanatory view illustrating the state where the key member is restrained by a second lock unit according to a drawing-out operation of the article removal jig;

FIG. 12 is an explanatory view illustrating the state where the active frame is drawn out from the disk array device by the article removal jig;

FIG. 13A illustrates the state where the key member is restrained by a first lock unit and the second lock unit, and FIG. 13B is an explanatory view illustrating the state where the second lock unit is released;

FIG. 14 is an explanatory view illustrating an article removal jig and an active frame in a second exemplary embodiment;

FIG. 15 is an explanatory view illustrating an article removal jig and an active frame in a third exemplary embodiment; and

FIG. 16 is an explanatory view illustrating an electromagnet and an electromagnetic switch which are provided in an article removal jig and an active frame in the third exemplary embodiment.

### DESCRIPTION OF EMBODIMENTS

Hereinafter, exemplary embodiments of the present disclosure will be described with reference to accompanying drawings. In the drawings, each portion does not be illustrated in such a manner that, the size and ratio completely conform to those of a real portion. Further, in some drawings, for the convenience of description, actually existing elements may be omitted, or some elements may be illustrated in an exaggerated size as compared to an actual size.

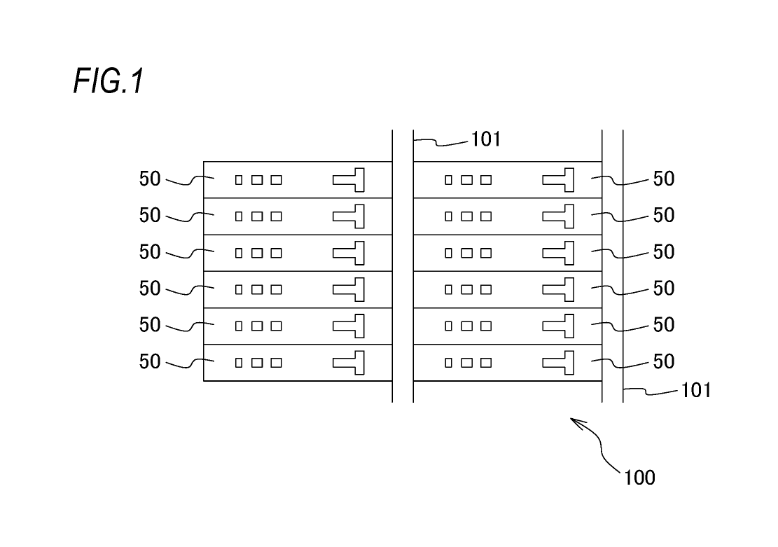

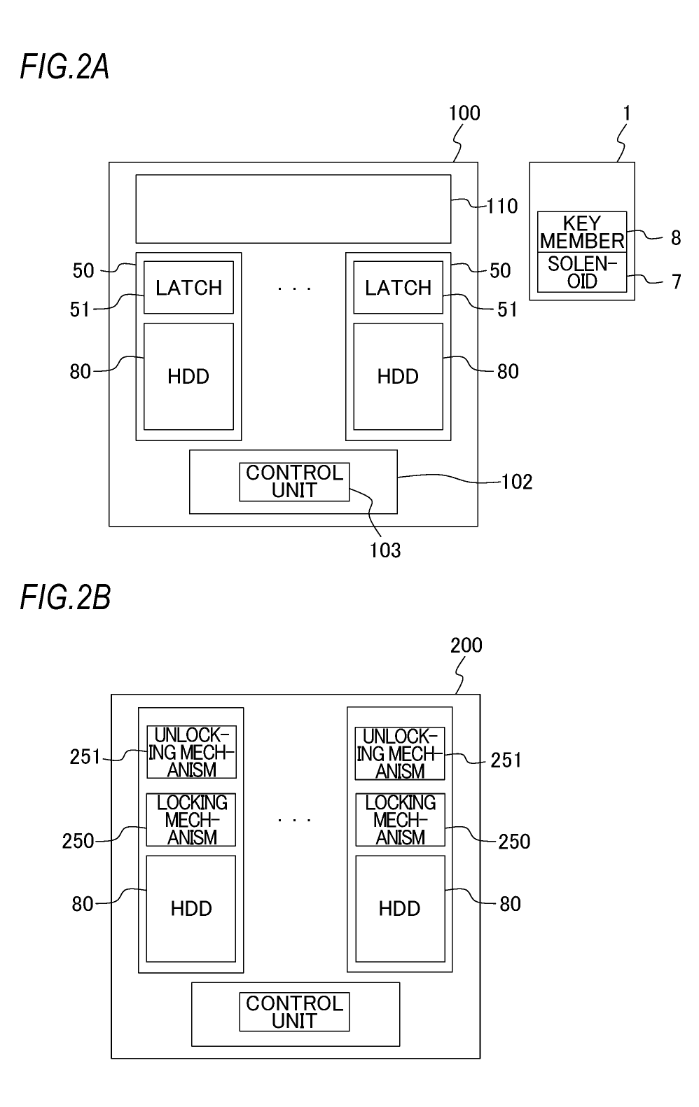

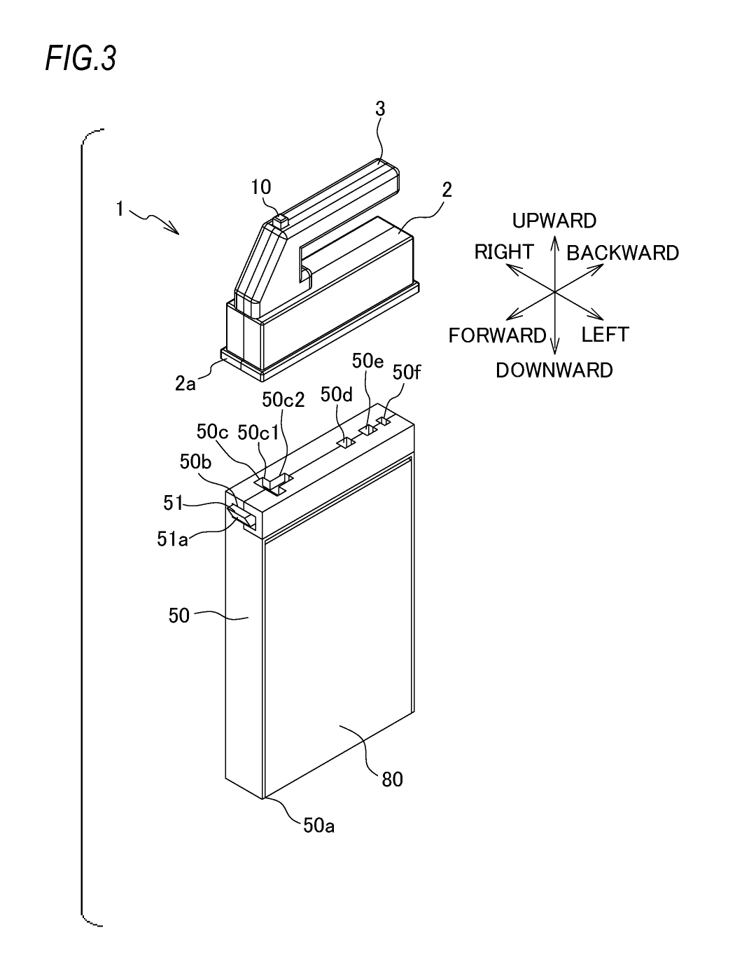

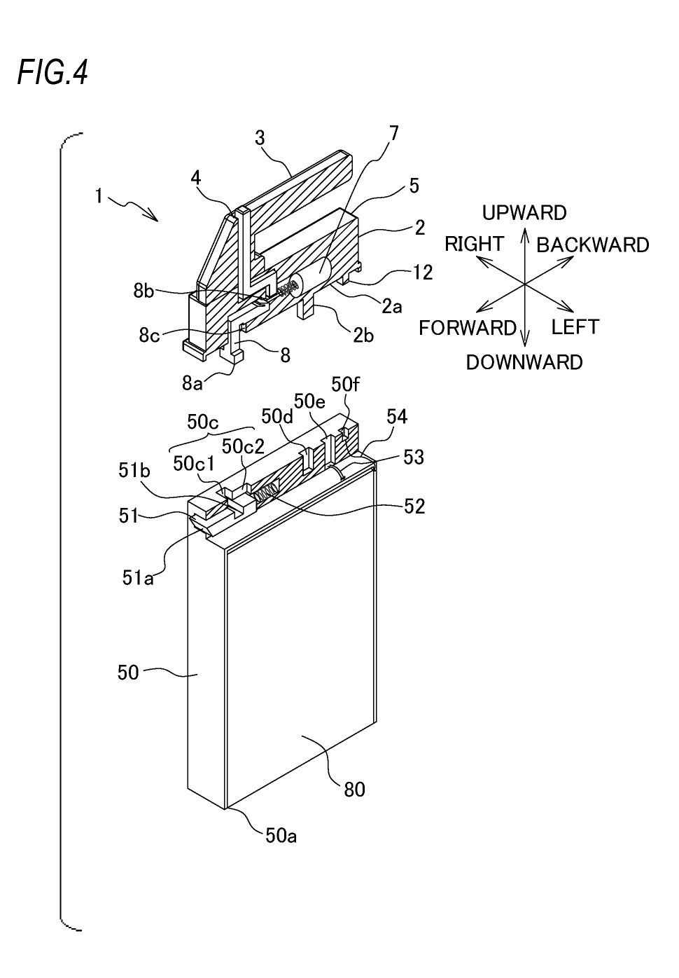

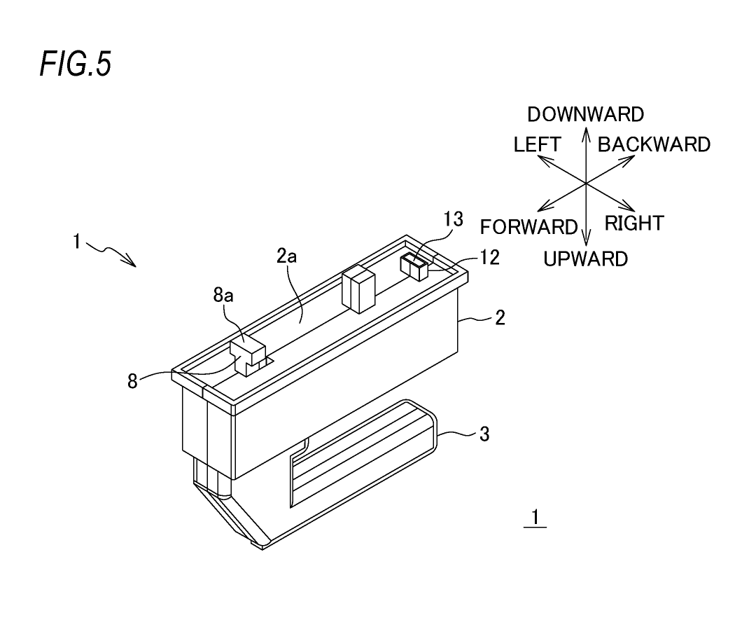

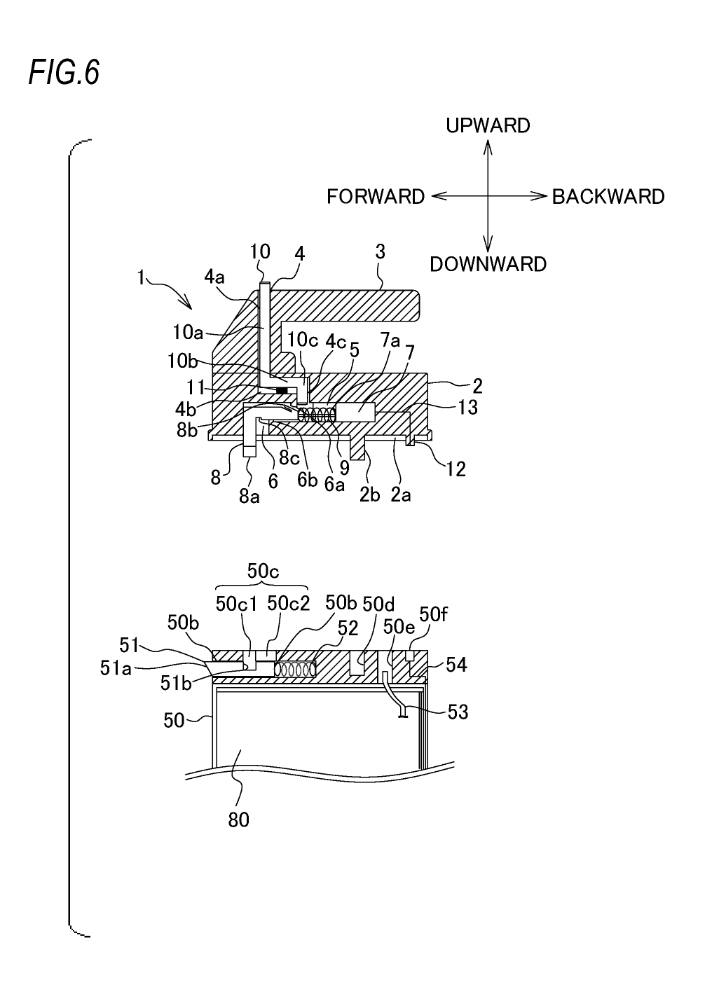

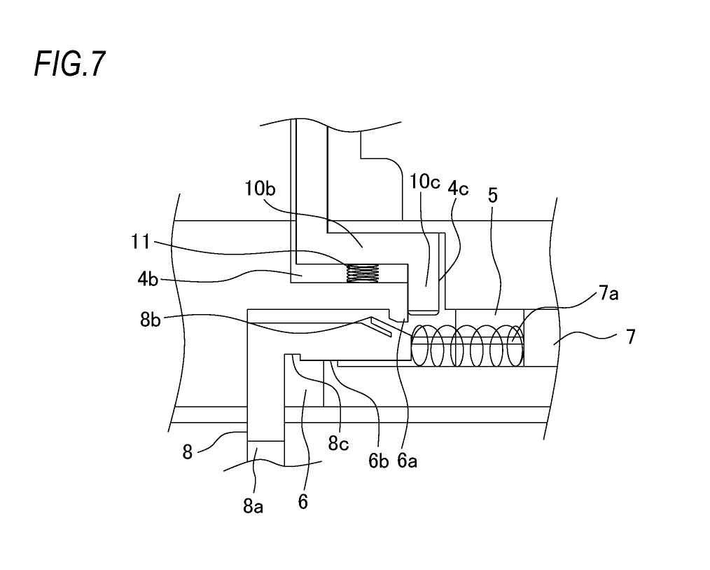

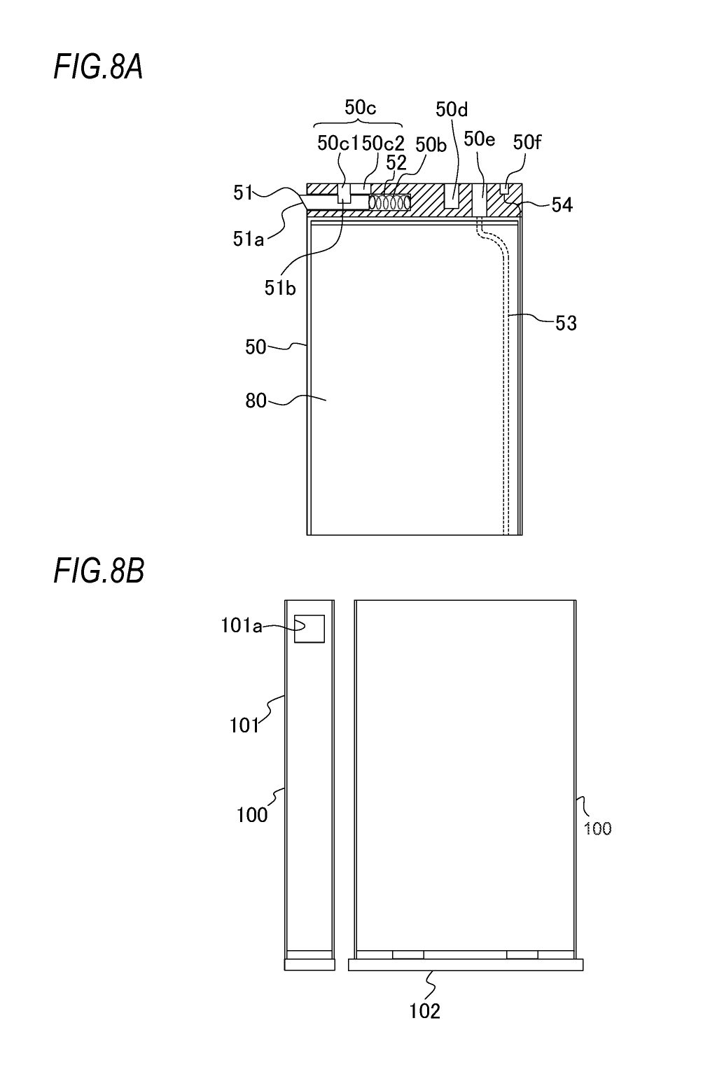

First, descriptions will be made on a disk array device 100 configured to accommodate active frames 50 and an article removal jig 1 configured to remove the active frames 50 from the disk array device 100 in a first exemplary embodiment with reference to FIGS. 1 to 8C. FIG. 1 is an explanatory view schematically illustrating a configuration of the disk array device 100 configured to accommodate the active frames 50 in a first exemplary embodiment. FIG. 2A is a block diagram of the disk array device 100 in the first exemplary embodiment. FIG. 2B is a block diagram of a disk array device in a comparative example. FIG. 3 is a perspective view illustrating the article removal jig 1 and an active frame 50 in the first exemplary embodiment. FIG. 4 is an explanatory view illustrating, partially in a cross-section, the article removal jig 1 and the active frame 50 in the first exemplary embodiment. FIG. 5 is a perspective view illustrating the article removal jig 1 in the first exemplary embodiment when viewed from a bottom side. FIG. 6 is a cross-sectional view illustrating main portions of the article removal jig 1 and the active frame 50 in the first exemplary embodiment. FIG. 7 is a cross-sectional view illustrating a main portion of the article removal jig 1 in the first exemplary embodiment in an enlarged scale. FIGS. 8A to 8C are explanatory views in which FIG. 8A illustrates the active frame 50, FIG. 8B illustrates the disk array device 100, and FIG. 8C illustrates a state where the active frame 50 is accommodated in the disk array device 100. In the following description, for convenience of explanation, a vertical direction, a lateral direction, and a front-rear direction are defined as indicated in FIG. 3 and other drawings.

In the present exemplary embodiment, the disk array device 100 corresponds to an article accommodating device. The disk array device 100 may utilize a plurality of hard disc drives (HDDs) 80 as in a single HDD by bundling up the plurality of HDDs. The HDDs 80 are installed in the disk array device 100 in a state where each HDD 80 is accommodated in one active frame 50. That is, in the present exemplary embodiment, the active frame 50 corresponds to an article accommodating body, and the HDD 80 corresponds to an article accommodated in the article accommodating body. The HDD 80 is an example of an electronic device.

Referring to FIG. 1, a plurality of active frames 50 is installed by being mounted on a post 101 provided in the disk array device 100. Referring to FIG. 2A, an article removal jig 1 is prepared separately from the disk array device 100. One or more article removal jigs 1 may be prepared. When the article removal jig 1 is prepared separately from the disk array device 100 as described above, a surplus space may be secured as indicated by reference numeral 110 in FIG. 2A. Referring to FIG. 2B, a disk array device 200 in a comparative example includes therein both a locking mechanism 250 of an HDD 80, and an unlocking mechanism 251 configured to release the state locked by the locking mechanism 250. The disk array device 100 of the present exemplary embodiment does not require an unlocking mechanism therein, and thus the surplus space 110 may be secured. Utilization of the space 110 is not limited. That is, since a mounting space for one HDD 80 is reduced, a high-density mounting may be achieved. When the high-density mounting is achieved, the size of the disk array device 100 may be reduced. In addition, a substrate 102 provided with a control unit 103, and a power supply unit (not illustrated) configured to supply a power from a main power source to each operating unit such as the control unit 103 or an HDD 80 are provided within the disk array device 100. The HDD 80 may obtain the power when a power supply connector provided in the HDD 80 is connected to a power supply connector provided in an active frame 50.

The active frame 50 includes a latch 51 which is provided to be retractable in relation to an engaging hole 101a provided in the post 101 of the disk array device 100. The latch 51 corresponds to an engaging unit. The active frame 50 is provided in the disk array device 100 when the latch 51 is engaged with the engaging hole 101a. The active frame 50 provided in the disk array device 100 is removed by the article removal jig 1. When the active frame 50 is installed in the disk array device 100, the active frame 50 may be pushed against the disk array device 100, and the latch 51 may be engaged with the engaging hole 101a.

<<Article Removal Jig>>

First, the article removal jig 1 will be described in detail. Referring to FIGS. 3 to 8C, the article removal jig 1 includes a main body 2, and a handle 3 continuously provided above the main body 2. A key member 8 is provided within the main body 2. The key member 8 is engaged with a recessed engaged unit 51b provided in the latch 51 which is provided in the active frame 50. The key member 8 includes a portion extending in the front-rear direction, and a portion extending in the vertical direction to be orthogonal to the former portion. A head portion 8a which extends in the lateral direction is provided at the bottom end of the vertically extending portion. A key member accommodating portion 6 is provided within the main body 2 of the article removal jig 1. The key member 8 is accommodated in the key member accommodating portion 6. The key member accommodating portion 6 includes a space extending in the front-rear direction and a space extending in the vertical direction to correspond to the shape of the key member 8. The head portion 8a of the key member 8 is provided to be exposed from the bottom surface of the main body 2. The key member 8 is movable in the front-rear direction in the key member accommodating portion 6. The key member 8 is provided within the key member accommodating portion 6 such that a clearance is also provided in the vertical direction. Thus, the key member 8 is slightly movable in the vertical direction.

Referring to FIG. 7, the key member 8 includes a first lock unit 8b which is restrained at a retracted position by a solenoid 7 to be described later, and is released by an operation of a releasing button member 10 to be described later. The first lock unit 8b may be engaged with a first engaging protrusion 6a provided at the rear end of the key member accommodating portion 6. The first lock unit 8b is formed in a flap shape, and upon being pressed down by an operation of the releasing button member 10 to be described later, the first lock unit 8b is disengaged from the first engaging protrusion 6a.

The key member 8 includes a second lock unit 8c which is restrained at a retracted position by the solenoid 7 according to a drawing-out operation of the article removal jig 1 when retracted by the solenoid 7 to be described later. The second lock unit 8c may be engaged with a second engaging protrusion 6b which is provided at a substantially middle portion of the key member accommodating portion 6, specifically, at the front end portion of the space extending in the front-rear direction. Here, the intent of the condition of “according to the drawing-out operation of the article removal jig 1” is that the vertical relative position of the main body 2 and the key member 8 is required to be changed when the main body 2 is pulled up by the handle 3. As described below, the solenoid 7 is powered from the active frame 50 side. Thus, when a drawing-out operation of the active frame 50 is initiated and the power supply to the solenoid 7 is interrupted, the retraction of the key member 8 by the solenoid 7 is released. Here, when no measure is taken, and further the releasing button member 10 is erroneously operated, the key member 8 may be pushed out forward. Then, when the second lock unit 8c is engaged with the second engaging protrusion 6b according to the drawing-out operation of the article removal jig 1, the return of the key member 8 to its initial position may be avoided.

The article removal jig 1 includes the solenoid 7 which drives the key member 8 so that the latch 51 is disengaged from the engaging hole 101a. The solenoid 7 is an example of a driver. The solenoid 7 is disposed within a solenoid accommodating portion 5 provided at the rear side of the key member 8. The solenoid 7 includes a shaft 7a. The shaft 7a is connected to the key member 8. The solenoid 7 is operated by being energized, and retracts the key member 8 backward so that the engagement between the latch 51 and the engaging hole 101a is released.

The article removal jig 1 includes a male connector portion 12 corresponding to a power receiving unit as a power source. To the male connector portion 12, a power is supplied from a female connector portion 50f which is provided in the active frame 50 and serves as a power supply unit. The male connector portion 12 is provided to protrude from the bottom surface of the main body 2. One end of a signal line 13 is located within the male connector portion 12. The other end of the signal line 13 is connected to the solenoid 7. In the present exemplary embodiment, the power supplied to the female connector portion 50f also serves as a removal permission signal of the active frame 50. For the active frame 50 as a target to be removed, an energizing command is issued by the control unit 103 provided in the disk array device 100. Only when the active frame 50, for which the energizing command is issued, is mounted with the article removal jig 1, the solenoid 7 provided in the article removal jig 1 may be operated so that the active frame 50 may be drawn out. Accordingly, a wrong active frame 50 is prevented from being drawn out. The removal permission is issued for an active frame 50 which accommodates an HDD 80 required to be replaced due to, for example, a failure.

The article removal jig 1 includes a first biasing member 9 which returns the key member 8 to its initial position. Here, the initial position indicates a position of the key member 8 when the solenoid 7 is not energized. The initial position in the present exemplary embodiment is a front end of the key member accommodating portion 6. The first biasing member 9 in the present exemplary embodiment is a coil spring. However, other types of members in other shapes may be employed as long as the members are capable of returning the key member 8 to its initial position.

The article removal jig 1 includes the releasing button member 10 received in a releasing button member accommodating portion 4 which is provided in the article removal jig 1. The releasing button member accommodating portion 4 includes a first space 4a which is opened at the top surface of the handle 3 and extends along the vertical direction, a second space 4b which extends from the lower end of the first space 4a to the rear side, and a third space 4c which extends downward from the rear end of the second space 4b. The third space 4c is communicated with the key member accommodating portion 6. The releasing button member 10 has a shape corresponding to the shape of the releasing button member accommodating portion 4. Specifically, the releasing button member 10 includes a first portion 10a located within the first space 4a, a second portion 10b located within the second space 4b, and a third portion 10c located within the third space 4c. The top portion of the first portion 10a is exposed from the handle 3. The bottom portion of the third portion 10c may be exposed to the key member accommodating portion 6 and press down the first lock unit 8b so that the first lock unit 8b is disengaged from the first engaging protrusion 6a. A support member 11 configured to support the releasing button member 10 is equipped within the second space 4b. The support member 11 is a coil spring, and biases the releasing button member 10 upward. The type and the shape of the support member 11 are not limited to those of the coil spring.

A frame-shaped holding recess 2a and a positioning convex portion 2b are provided on the bottom side of the article removal jig 1. The holding recess 2a and the positioning convex portion 2b are positioned when the article removal jig 1 is mounted on the active frame 50.

<<Active Frame>>

Hereinafter, an active frame 50 which is an article accommodating body will be described. Referring to FIGS. 3, 4, and 6, the active frame 50 includes an article accommodating unit 50a. In the article accommodating unit 50a of the present exemplary embodiment, an HDD 80 is accommodated. The active frame 50 includes a latch 51. The latch 51 is provided to be retractable in relation to an engaging hole 101a provided in the post 101 which is provided in the disk array device 100. The latch 51 is provided with a recessed engaged unit 51b to be engaged with the key member 8 provided in the article removal jig 1. The latch 51 is accommodated in a latch accommodating portion 50b. The front end portion of the latch 51 projects from and retracts in an opening 50b1 provided at the end of the latch accommodating portion 50b. A tapered surface 51a is provided at the front end portion of the latch 51. The tapered surface 51a is an inclined surface which extends inwardly from the top side to the bottom side. When the active frame 50 to be installed in the disk array device 100 is pushed toward the setting position, the tapered surface 51a comes in contact with the end portion of the post 101a so that the latch 51 is smoothly pushed. The engaged unit 51b is formed in a recessed shape so that the head portion 8a of the key member 8 provided in the article removal jig 1 may be engaged with the engaged unit 51b. The latch 51 is biased toward the engaging hole 101a side, that is, the outside, by a second biasing member 52.

The active frame 50 includes a key slot 50c, and the key member 8 provided in the article removal jig 1 is inserted through the key slot 50c to be engaged with the key member 8. The key slot 50c includes an introducing slot 50c1 which has a size capable of accommodating the head portion 8a of the key member 8, and a sliding slot 50c2 which is continuously provided at the rear side of the introducing slot 50c1 and allows the key member 8 to slide therein. The width of the sliding slot 50c2 is narrower than the width of the introducing slot 50c1. Thus, when the key member 8 is retracted by the solenoid 7 and slid along the sliding slot 50c2, the head portion 8a of the key member 8 is engaged with both sides of the sliding slot 50c2. In this state, when the article removal jig 1 is drawn out, the active frame 50 may be removed. The second biasing member 52 is set to be placed in a free length state when the engaged unit 51b matches with the introducing slot 50c1.

As described above, the active frame 50 includes the female connector portion 50f engageable with the male connector portion 12 provided in the article removal jig 1. The female connector portion 50f serves as a signal transmitter which transmits a removal permission signal that permits disengagement of the latch 51 from the engaging hole 101a to the article removal jig 1, and serves as a power supply unit for driving the solenoid 7. The female connector portion 50f is connected to the substrate 102 through a signal line 54, and the female connector portion 50f provided in the active frame 50 which is permitted to be removed is energized by the control unit 103. When the male connector portion 12 provided in the article removal jig 1 is fitted in the energized female connector portion 50f, the solenoid 7 is operated. In this manner, the female connector portion 50f serves as a removal permission signal.

The active frame 50 includes a positioning hole 50d. The positioning convex portion 2b provided in the article removal jig 1 is inserted in the positioning hole 50d so that the article removal jig 1 is positioned in relation to the active frame 50. The active frame 50 includes a light emitting portion 50e. One end of an optical waveguide 53 is connected to the light emitting portion 50e. The other end of the optical waveguide 53 is connected to the substrate 102. The light emitting portion 50e emits light when removal permission is issued for an active frame 50 so as to inform an operator of the active frame 50 for which the removal permission is issued.

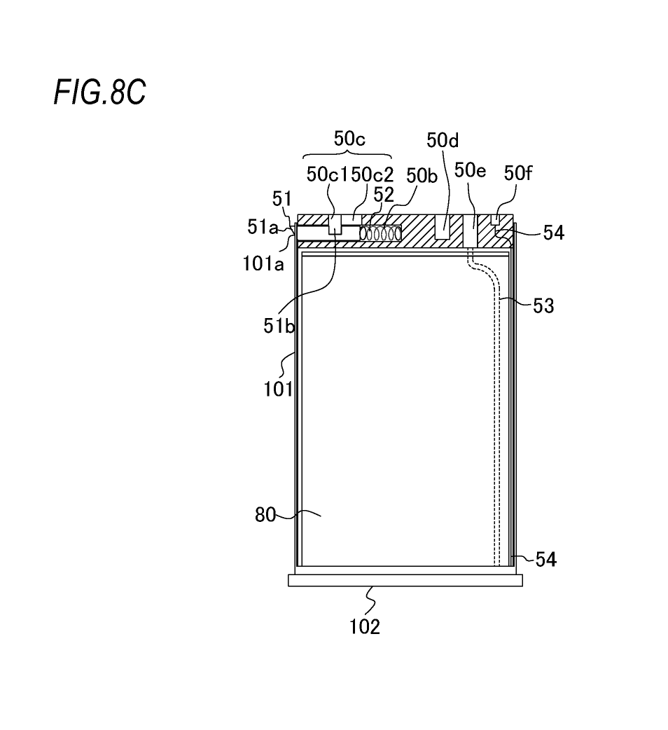

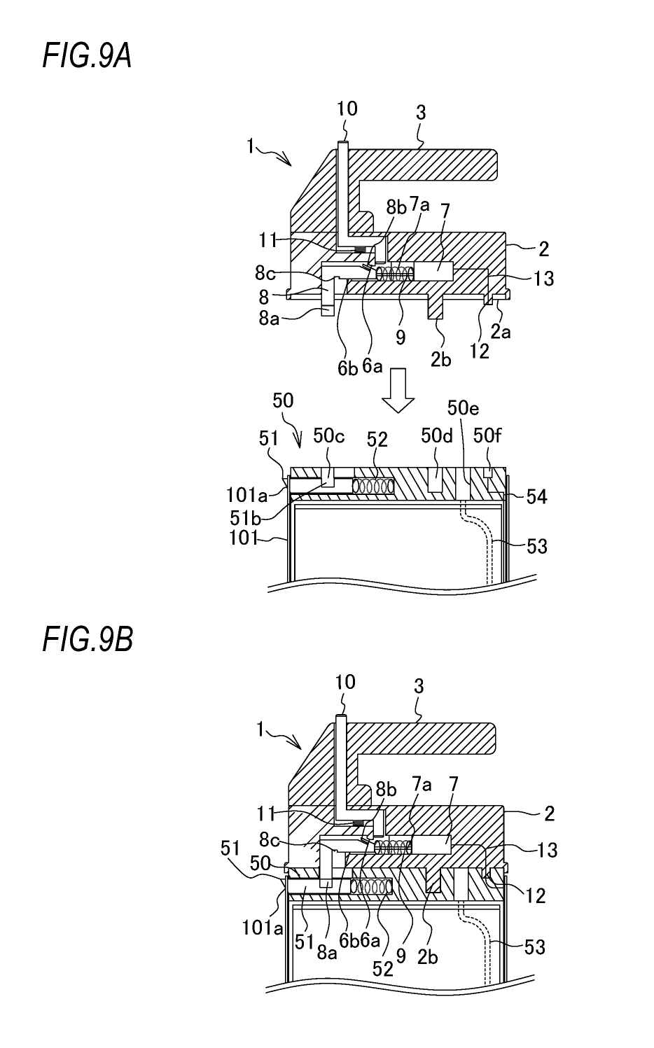

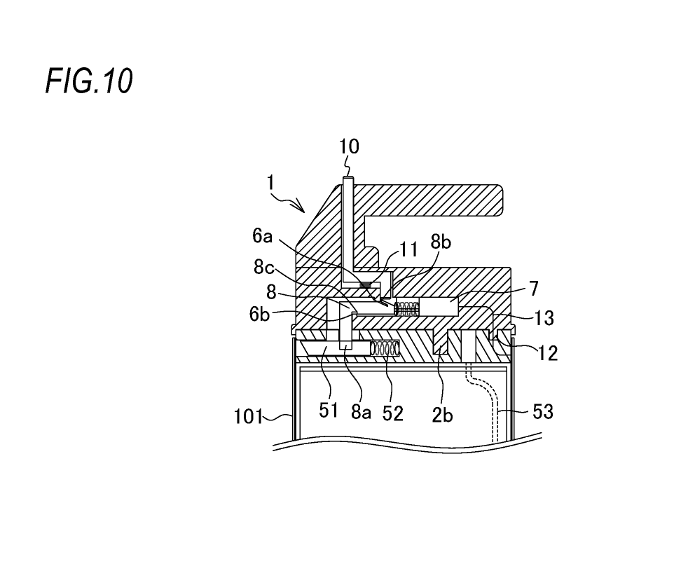

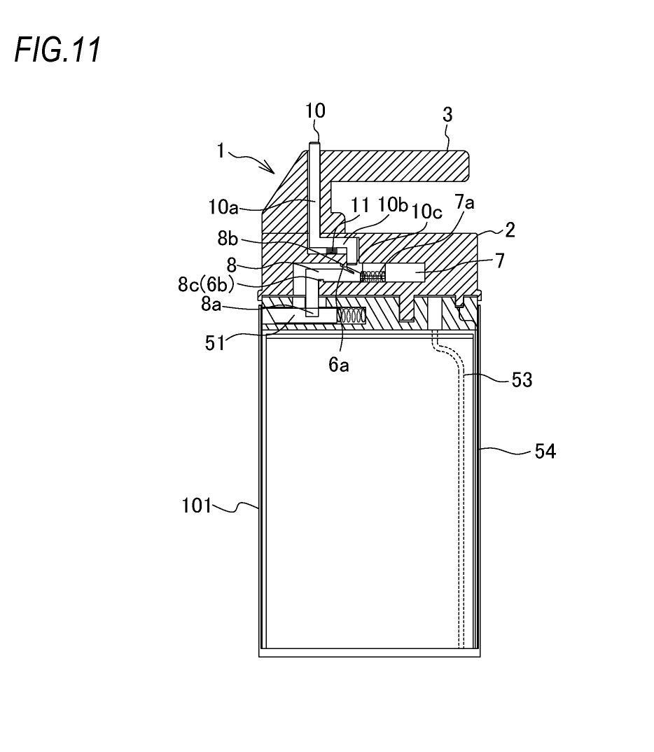

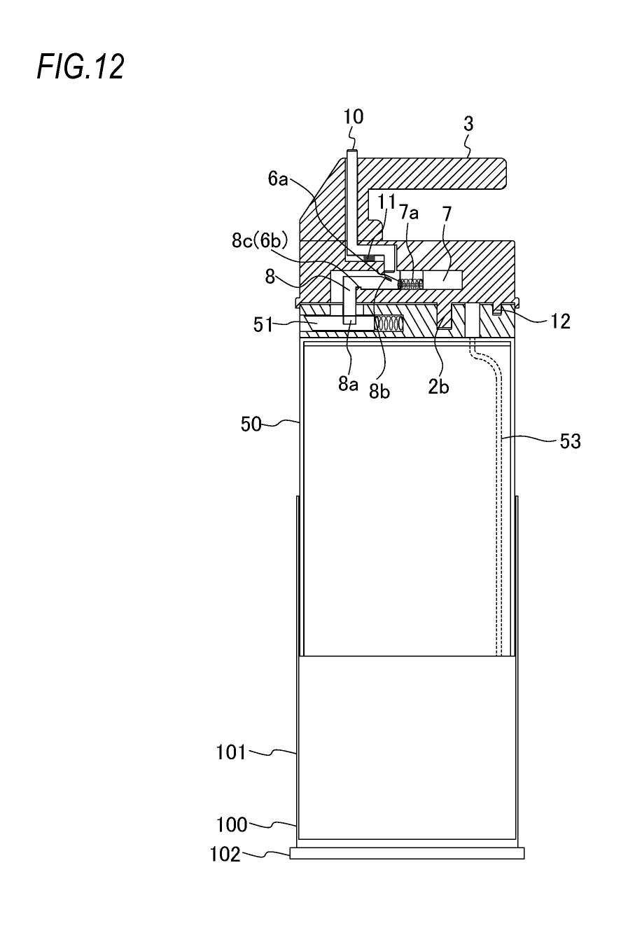

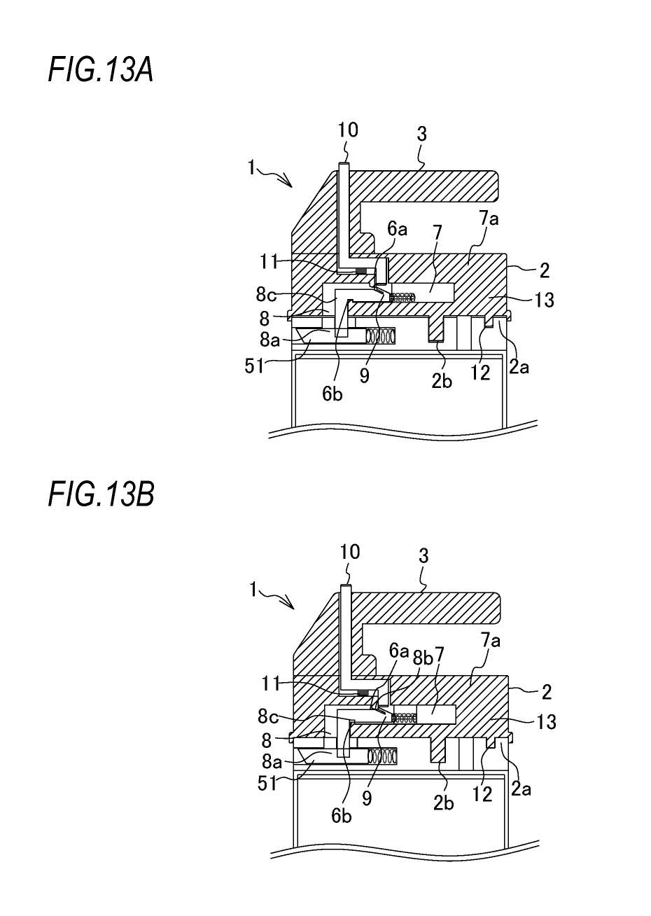

Hereinafter, descriptions will be made on the state when the active frame 50 is removed from the disk array device 100 with reference to FIGS. 9A to 13B. FIG. 9A illustrates a preparation state before the article removal jig 1 is mounted on the active frame 50 in the first exemplary embodiment, and FIG. 9B is an explanatory view illustrating the state where the article removal jig 1 is mounted on the active frame 50. FIG. 10 is an explanatory view illustrating the state where the latch 51 is retracted by the key member 8. FIG. 11 is an explanatory view illustrating the state where the key member 8 is restrained by the second lock unit 8c according to a drawing-out operation of the article removal jig 1. FIG. 12 is an explanatory view illustrating the state where the active frame 50 is drawn out from the disk array device 100 by the article removal jig 1. FIG. 13A illustrates the state where the key member 8 is restrained by the first lock unit 8b and the second lock unit 8c, and FIG. 13B is an explanatory view illustrating the state where the second lock unit 8c is released.

Referring to FIG. 9A, when the active frame 50 is installed in the disk array device 100, the latch 51 is engaged with the engaging hole 101a. Here, the engaged unit 51b corresponds to the position of the introducing slot 50c1. In this state, when a removal permission signal is issued for the active frame 50 required to be replaced due to, for example, a failure of the HDD 80, the female connector portion 50f is energized. In addition, the light emitting portion 50e emits light. The operator may find the active frame 50 required to be replaced using the light emission of the light emitting portion 50e as a clue.

Meanwhile, the solenoid 7 provided in the article removal jig 1 is not energized, and the key member 8 provided in the article removal jig 1 is pushed forward by the first biasing member 9 (initial state). Here, the position of the head portion 8a corresponds to the position of the introducing slot 50c1. The key member 8 rides on the first engaging protrusion 6a.

The operator mounts the article removal jig 1 on the active frame 50 of which the light emitting portion 50e emits light, as illustrated in FIG. 9B. Accordingly, the male connector portion 12 is fitted to the female connector portion 50f to energize the solenoid 7. When the solenoid 7 is energized, as illustrated in FIG. 10, the key member 8 and the latch 51 are retracted. Accordingly, the head portion 8a of the key member 8 is introduced into the bottom side of the sliding slot 50c2 to be engaged with the active frame 50, and the engagement of the latch 51 and the engaging hole 101a is released so that the active frame 50 may be drawn out. Here, the first lock unit 8b provided in the key member 8 is engaged with the first engaging protrusion 6a. Meanwhile, the second lock unit 8c is not engaged with the second engaging protrusion 6b. This is because the head portion 8a is grounded on the bottom surface of the engaged unit 51b so that the vertical position of the key member 8 is maintained.

As described above, the operator mounts the article removal jig 1 on the active frame 50 as a target using the light emission of the light emitting portion 50e as a sign. Even if the operator mounts the article removal jig on a wrong active frame 50, the female connector portion 50f of the active frame 50 is not energized and the solenoid 7 is not operated, and thus the active frame 50 cannot be drawn out.

Referring to FIG. 11, when an operation of drawing out the article removal jig 1 is made by the operator holding the handle 3, only the article removal jig 1 is temporarily raised slightly. Here, the head portion 8a introduced into the bottom side of the sliding slot 50c2 is pressed down by the active frame 50, and then key member 8 is moved relatively downward, and the main body 2 of the article removal jig 1 is moved upward. Accordingly, the second engaging protrusion 6b and the second lock unit 8c are engaged with each other.

As illustrated in FIG. 12, when the article removal jig 1 is further drawn out, the active frame 50 is drawn out from the disk array device 100. As a result, energization to the female connector portion 50f which is separated from the substrate 102 is interrupted, and energization to the solenoid 7 is stopped. However, at this point, the first lock unit 8b is engaged with the first engaging protrusion 6a, and the second lock unit 8c is engaged with the second engaging protrusion 6b so that the key member 8 is restrained in its position. In this state, when the releasing button member 10 is operated by mistake, the restraint of the key member 8 is maintained by the engagement of the second lock unit 8c with the second engaging protrusion 6b. That is, since the head portion 8a is maintained in the state where it is introduced into the bottom side of the sliding slot 50c2 is maintained, the engagement of the article removal jig 1 with the active frame 50 is also maintained.

Referring to FIG. 13A, the key member 8 is restrained by the first lock unit 8b and the second lock unit 8c. This indicates the state where the article removal jig 1 is pulled up, and the active frame 50 is suspended on the article removal jig 1 to be separated from the disk array device 100. As a result, the second engaging protrusion 6b and the second lock unit 8c are still meshed and engaged with each other. In this state, for example, when the active frame 50 is placed on a base, and the pulled-up state of the article removal jig 1 is released, the active frame 50 and the article removal jig 1 are in close contact. As a result, the main body 2 is relatively lowered as compared to the key member 8, and the second engaging protrusion 6b is disengaged from the second lock unit 8c. In this state, when the releasing button member 10 is pressed down, the first lock unit 8b is pressed down and disengaged from the first engaging protrusion 6a. Then, the key member 8 biased to the first biasing member 9 is returned to the initial position. Thus, the head portion 8a is moved to the lower side of the introducing slot 50c1. Accordingly, the key member 8 may be disengaged from the key slot 50c so that the article removal jig 1 is removable from the active frame 50.

The above description corresponds to a series of operations for removing the active frame 50 from the disk array device 100. According to the article removal jig 1 and the active frame 50 of the present exemplary embodiment, a mechanism for releasing the locked state of the active frame 50 in the disk array device 100 is provided at the article removal jig 1 side. Thus, the space efficiency is improved at the disk array device 100 side. In addition, in the present exemplary embodiment, it is not necessary to provide an unlocking mechanism in each active frame 50. This also provides an advantage in terms of the space efficiency. In addition, unless the article removal jig 1 is mounted on the active frame 50 permitted to be removed, the key member 8 provided in the article removal jig 1 is not operated. Thus, a wrong removal may be avoided.

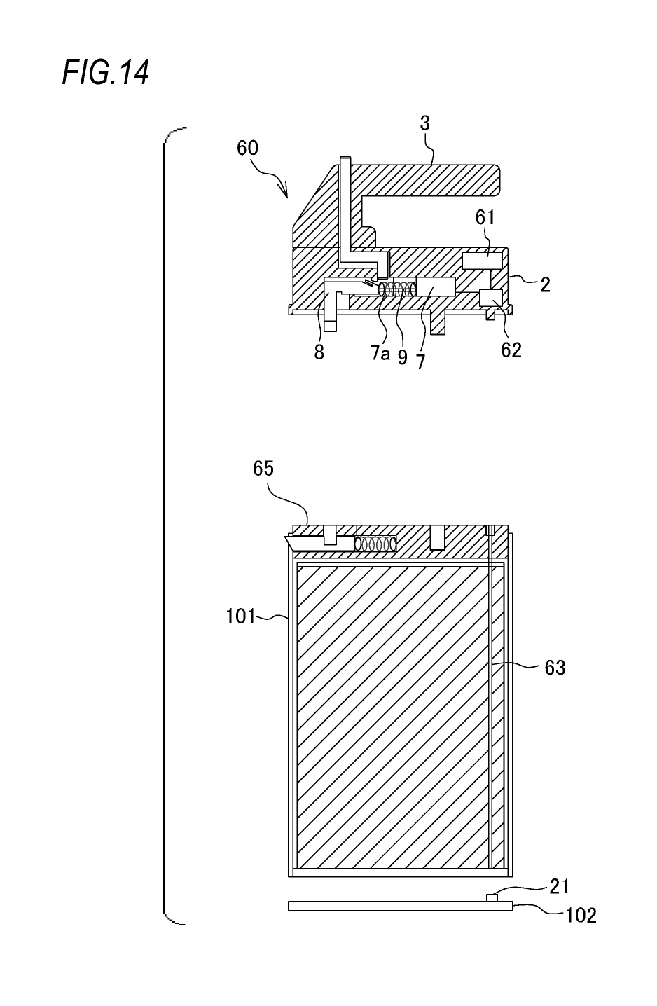

Hereinafter, a second exemplary embodiment will be described with reference to FIG. 14. In the first exemplary embodiment, the male connector portion 12 is fitted to the female connector portion 50f to supply a power to the solenoid 7. In contrast, in the second exemplary embodiment, a battery 61 for driving the solenoid 7 is provided as a power source in an article removal jig 60. In addition, in the first exemplary embodiment, the male connector portion 12 is fitted to the female connector portion 50f to transmit/receive a removal permission signal. However, the article removal jig 60 of the second exemplary embodiment includes an optical sensor 62 as a signal receiver of a removal permission signal. The optical sensor 62 detects light of a light emitting unit 21 equipped in the substrate 102. That is, the optical sensor 62 detects light of the light emitting unit 21 which is guided through an optical waveguide 63 provided within an active frame 65. The optical waveguide 63 serves as a signal transmitter. The light emitting unit 21 serves as a removal permission signal by emitting light when removal permission is issued. The light emission of the light emitting unit 21 also serves as a sign which informs an operator of an active frame 65 for which removal permission is issued.

When the operator mounts the article removal jig 60 on the active frame 65 using the light emission of the light emitting unit 21 through the optical waveguide 63 as a sign, the optical sensor 62 detects the light and supplies the power of the battery 61 to the solenoid 7. Accordingly, the article removal jig 60 may implement the same operation as that of the first exemplary embodiment. Some elements which are the same as those in the first exemplary embodiment are given the same reference numerals in the drawings, and detailed descriptions thereof will be omitted.

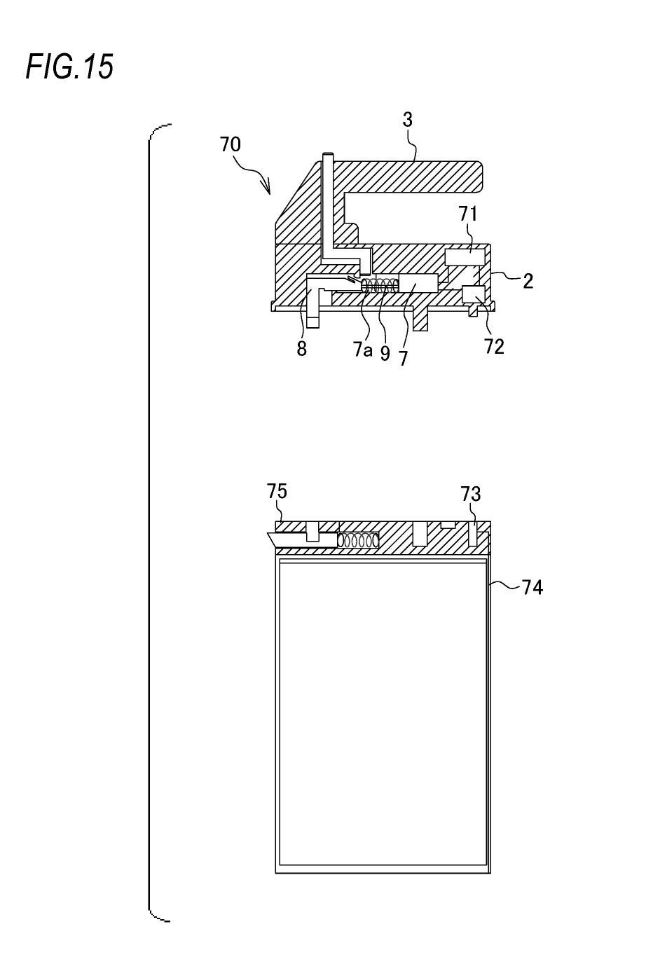

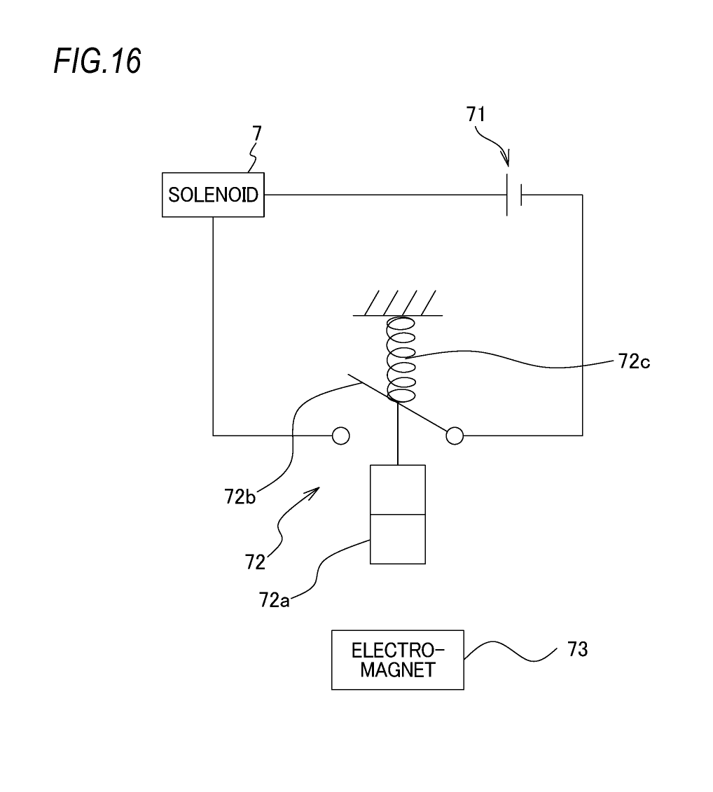

Hereinafter, a third exemplary embodiment will be described with reference to FIGS. 15 and 16. In the second exemplary embodiment, the optical waveguide 63 is provided as a signal transmitter, and the optical sensor 62 is provided as a signal receiver of a removal permission signal. In contrast, in the third exemplary embodiment, an electromagnet 73 is provided as a signal transmitter, and an electromagnetic switch 72 is provided as a signal receiver of a removal permission signal. Referring to FIG. 16, the electromagnetic switch 72 includes a magnet portion 72a, a contact portion 72b, and a spring member 72c. The electromagnetic switch 72 is connected to a battery 71 and the solenoid 7. When the electromagnetic switch 72 approaches the energized electromagnet 73, the magnet portion 72a is attracted to the electromagnet 73 so that the contact portion 72b is placed in a contact state. Accordingly, the power of the battery 71 is supplied to the solenoid 7. When the magnet portion 72a is separated from the electromagnet 73, the contact portion 72b is returned to its original position by the spring member 72c, thereby interrupting the energization.

The electromagnet 73 is energized when the removal permission is issued. When an article removal jig 70 is mounted on an active frame 75, of which the electromagnet 73 is energized, the electromagnetic switch 72 is operated as described above, thereby supplying power to the solenoid 7. Accordingly, the article removal jig 70 may implement the same operation as that of the first exemplary embodiment or the second exemplary embodiment. Some elements which are the same as those in the first exemplary embodiment are given the same reference numerals in the drawings, and detailed descriptions thereof will be omitted.

In the respective exemplary embodiments as described above, an article accommodating device is a disk array device, an article accommodating body is an active frame, and an article to be accommodated in the active frame is an HDD. However, the article accommodating device, and the article accommodating body disclosed herein may be applied to warehouses or other applications. For example, the article accommodating device may be operated as an archive while the article accommodating body accommodates books. The article accommodating device may be operated as a safe, while the article accommodating body accommodates valuables. In this manner, the article removal jig, or the article accommodating body disclosed herein may be applied to applications for accommodating articles in a rack or a cabinet. When the article removal jig is used in such applications, a wrong article accommodating body may not be drawn out.

Although exemplary embodiments of the present disclosure have been described in detail, the present disclosure is not limited to the specific exemplary embodiments. Various modifications and changes may be made within the scope of the present disclosure described in the claims.

What is claimed is:

1. An article removal jig, comprising:
an engaging unit provided to be retractable in relation to an engaging hole provided in an article accommodating device, the engaging unit being engaged in the engaging hole such that an article accommodating body provided in the article accommodating device is removed from the article accommodating device;
a handle;
a key member configured to be engaged with an engaged unit provided in the engaging unit provided in the article accommodating body;
a driver configured to drive the key member to disengage the engaging unit from the engaging hole;
a power source mounted on the article accommodating body which is permitted to be removed from the article accommodating device, the power source being configured to supply a power to the driver when receiving a removal permission signal of the article accommodating body which is permitted to be removed; and
a first biasing member configured to return the key member to an initial position.

2. The article removal jig according to claim 1, wherein the power source includes a power receiving unit to which the power is supplied from a power supply unit provided in the article accommodating body.

3. The article removal jig according to claim 1, wherein the power source includes a signal receiver of the removal permission signal, and a battery.

4. The article removal jig according to claim 1, wherein the key member includes a first lock unit which is retracted to and restrained at a retracted position by the driver and released from the restraint according to an operation of a releasing button member.

5. The article removal jig according to claim 1, wherein the key member includes a second lock unit which is restrained at a retracted position according to a drawing-out operation of the article removal jig when retracted by the driver.

6. The article removal jig according to claim 1, which removes the article accommodating body in which an electronic device is accommodated.

7. An article accommodating body provided in an article accommodating device to be removed from the article accommodating device by an article removal jig, the article accommodating body comprising:
an engaging unit provided to be retractable in relation to an engaging hole provided in the article accommodating device, and including an engaged unit to be engaged with a key member provided in the article removal jig;
a second biasing member configured to bias the engaging unit toward the engaging hole;
a key slot through which the key member is inserted to be engaged with the key slot; and
a signal transmitter configured to transmit a removal permission signal to the article removal jig to permit release of the engagement of the engaging unit and the engaging hole.

8. The article accommodating body according to claim 7, wherein the signal transmitter includes a power supply unit configured to supply a power to a power receiving unit provided in the article removal jig.

9. The article accommodating body according to claim 7, wherein the signal transmitter is an optical waveguide or an electromagnet.

10. The article accommodating body according to claim 7, wherein the article accommodating body accommodates an electronic device.
